(19) United States
(12) Patent Application Publication
(10) Pub. No.: US 2026/0034462 A1
(43) Pub. Date: Feb. 5, 2026

(54) SWING CONFIGURED FOR USE WITH ONE OR MORE MOBILITY DEVICES

(71) Applicant: PlayCore Wisconsin, Inc., Chattanooga, TN (US)

(72) Inventors: Thomas Robert Norquist, Fort Payne, AL (US); Jinquan Zhu, Auburn, AL (US); Lloyd W. Reese, Farmington, MO (US); Charles Griffith, Fort Payne, AL (US)

(21) Appl. No.: 19/287,680

(22) Filed: Jul. 31, 2025

Related U.S. Application Data
(60) Provisional application No. 63/678,397, filed on Aug. 1, 2024.

(51) Int. Cl. A63G 9/02; A61G 3/08

(52) U.S. Cl. CPC A63G 9/02; A61G 3/0808

(57) ABSTRACT

A swing for use by children or adults in mobility devices, such as wheelchairs, includes a base platform configured to support one or more mobility devices and which is connected, through a rigid framework, to one or more overhead trolleys. The one or more overhead trolleys are configured to move back and forth along first and second elevated and desirably curved tracks, thereby causing the base platform to swing frontward and rearward in a to-and-fro swinging motion.

This application claims priority to U.S. Provisional Application No. 63/678,397, filed on Aug. 1, 2024, the entirety of which is incorporated by reference herein.

### BACKGROUND

Opportunities for children on wheelchairs, power chairs, mobility scooters and the like on conventional playgrounds are limited. In particular, swings have proven difficult to design given the need for the swing to support increased weights associated with such mobility devices and yet be safe enough for use in a playground setting, where children may inadvertently run into the path of the swing during operation.

### SUMMARY OF THE INVENTION

The present disclosure is directed to a swing that is configured to support one or more users of mobility devices such as wheelchairs, power chairs, mobility scooters, or the like (which may collectively be referred to herein as wheelchairs for simplicity). The swing is designed to support the increased weight associated with such a device while still being safe enough for use in a playground setting.

Embodiments of the present disclosure are directed to a swing configured for use by a person on a wheelchair or other such mobility device that includes a base platform that is configured to support at least one wheelchair (or other such mobility device) and move in a to-and-fro swinging motion. The swing further includes first and second elevated (i.e. overhead) tracks, each of the first and second elevated tracks being held in an elevated position by a support structure. A first set of one or more trolleys is configured to move along the first elevated track and a second set of one or more trolleys is configured to move along the second elevated track. The base platform is connected to each of the first set of one or more trolleys and the second set of one of more trolleys by a rigid framework. Accordingly, as the trolleys move along the first and second elevated tracks, the base platform swings in a to-and-fro swinging motion.

In some embodiments of the swing disclosed herein, the first and second elevated tracks may run in a direction that is substantially parallel with the first and second sides of the base platform. Whether or not the elevated tracks are substantially parallel with the sides of the base platform, each of the elevated tracks may be curved, or arced, so that each track curves upward from the center toward each of the first and second ends. By providing tracks that curve upward toward each end, the motion of the platform, and thus of the one or more wheelchairs supported thereon, produced by movement of the trolleys along the tracks is similar to the swinging motion provided by a conventional playground swing.

The curvature of the tracks may be selected to provide a desired swinging experience. A track having a curve with a greater inclination at each end, and thus a lower radius of curvature, will produce a more intense swinging motion and a track having a curve with a lesser inclination at each end, and thus a greater radius of curvature, will produce a more subtle swinging motion. In some embodiments, the first and second tracks may have a radius of curvature between about 10 feet and about 30 feet, alternatively between about 12 feet and about 28 feet, alternatively between about 15 feet and about 25 feet, alternatively between about 17 feet and about 23 feet, alternatively about 20 feet.

Along with the curvature of the tracks, the user experience will also depend on the length that the swing travels along the tracks. This can be measured as the arc travelled by the center of the base platform during a swinging motion. In some embodiments, the base platform may travel through an arc between about 5 degrees and about 25 degrees, alternatively between about 5 degrees and about 20 degrees, alternatively between about 7 degrees and about 17 degrees, alternatively between about 9 degrees and about 15 degrees, alternatively about 12 degrees.

Each of the first and second elevated tracks may include an impact dampening component at each end. In that way, the platform will not come to an abrupt stop that could jostle the one or more wheelchairs and/or other occupants of the swing when it reaches the ends of the tracks but rather the trolley will be slowed and/or cushioned at the ends of the tracks to provide a smooth transition from movement in one direction to movement in the opposite direction.

Embodiments of the swing are configured to support a wheelchair at a first end of the base platform, at a second end of the base platform, or at both ends of the base platform. In some embodiments, the swing may be configured to support a person that is not on a wheelchair at the first end of the base platform, at the second end of the base platform, or at both ends of the base platform. To support a user that is not in a wheelchair, the swing may include a rigid bench seat. In some embodiments, the swing may be configured to support a first wheelchair at a first end of the base platform and a second wheelchair at a second end of the base platform.

In some embodiments, the swing may be configured so that a person that is in a wheelchair and a person that is not in a wheelchair may sit side-by-side at either the first end of the base platform, the second end of the base platform, or both. In such an embodiment, for example, a rigid bench seat may extend across a portion of the base platform with the remaining portion forming a gap for a wheelchair. In other embodiments, a first end of the base platform may be configured to support a wheelchair and a second end of the base platform may be configured to support a person that is not in a wheelchair. For example, a first end of the base platform may be configured to support a wheelchair and a second end of the base platform may comprise a rigid bunch seat that spans substantially the entire width of the base platform.

Each end of the base platform may comprise an end wall. The end wall may extend across the end of the platform (from side to side) and may also extend a distance along each of the first and second sides of the base platform. Each end wall is desirably rounded to reduce impact force. Each end wall may also include impact-attenuating components or materials.

Embodiments of the swing may also include one or more components that prevent rolling of the wheels of a wheelchair at the one or more positions where the swing is configured to support a wheelchair during use. These components may be located on the base platform, on the end wall, or both, and may include projections, depressions, movable bars, straps, or the like, or any combination thereof. It is also contemplated that in some embodiments a user of a wheelchair, if physically able, may grasp a portion of the framework, a portion of the end wall, etc., to stabilize the wheelchair in place during the swinging motion.

In some embodiments, the rigid framework of the swing may include a first set of two or more members, each of which has a first end connected to the base platform along the first side of the base platform and a second end operably connected to the first set of one or more trolleys, and a second set of two or more members, each of which has a first end connected to the base platform along the second side of the base platform and a second end operably connected to the second set of one or more trolleys. The members may be directly connected to the base platform, e.g. through welding, fasteners, or the like, or indirectly connected to the base platform, e.g. through one or more additional elements. Similarly, the members may be directly or indirectly connected to the trolleys. The swing may be configured for a user in a wheelchair to enter and exit the base platform via a ramp (a) on the first side of the base platform between the first set of two or more members, (b) on the second side of the base platform between the second set of two or more members, or (c) both (a) and (b).

In some embodiments, the first set of one or more trolleys comprises at least two trolleys, and the second set of one or more trolleys comprises at least two trolleys. In such an embodiment, the rigid framework may include a first member having a first end connected to the base platform along a first side of the base platform and a second end connected to a first one of the at least two trolleys of the first set of one or more trolleys, a second member having a first end connected to the base platform along a first side of the base platform and a second end connected to a second one of the at least two trolleys of the first set of one or more trolleys, a third member having a first end connected to the base platform along a second side of the base platform and a second end connected to a first one of the at least two trolleys of the second set of one or more trolleys, and a fourth member having a first end connected to the base platform along a second side of the base platform and a second end connected to a second one of the at least two trolleys of the second set of one or more trolleys. In such an embodiment, the swing may be configured for a user in a wheelchair to enter and exit the base platform via a ramp (a) on the first side of the base platform between the first and second members, (b) on the second side of the base platform between the third and fourth members, or (c) both (a) and (b).

In some embodiments, the rigid framework may further comprise one or more crossbars, each of which connects a member along the first side of the base platform with a member along the second side of the base platform, e.g. one of the first set of members and one of the second set of members. In some embodiments having the trolley and framework arrangement described in the previous paragraph, for instance, the rigid framework may further comprise at least a first crossbar that connects the first member and the third member and a second crossbar that connects the second member and the fourth member. The crossbars provide additional structural stability and prevent undesired stresses from being placed on the framework due to rocking of the platform and the like. Additional crossbars and/or braces may also be included, depending on how many mobility devices the swing is configured to support.

In some embodiments of a swing according to the present disclosure, the underside of the base platform may be positioned at least twelve inches above an underlying play surface at the lowest point during a swinging motion, optionally at least thirteen inches above the underlying play surface, optionally at least fourteen inches above the underlying play surface, optionally at least fifteen inches above the underlying play surface, optionally at least sixteen inches above the underlying play surface. Further, the space between the underside of the base platform and the play surface (e.g. ground surface) to which the support structure is mounted may be free of any skirt or elevated platform.

In some embodiments, the swing according to the present disclosure may be configured to have a peak acceleration of 100 g or less and a head impact score of 500 or less, each of which being tested in accordance with ASTM F1387, section 8.6.7.

In some embodiments, the swing according to the present disclosure may include a system that limits side-to-side movement of the base platform during the swinging motion. This stabilization system may take on any of a variety of different configurations.

In some embodiments, the system configured to limit side-to-side movement of the base platform during the swinging motion comprises a track on an underside of the base platform and a trolley that is fixed in place below the base platform, and configured so that the track moves, e.g. slides, about the fixed trolley during the swinging motion. The trolley may include a plurality of wheels or other rollers that are configured to roll along one or more walls of the track, thereby reducing the friction between the track and the trolley and minimizing the effect of the stabilization system on the swinging motion.

In some embodiments, the track may be mounted substantially centrally between a first side and a second side of the base platform. The track may also spans substantially the length of the base platform between a first end and a second end. The trolley may be mounted to a ground surface below the base platform and may be positioned at the substantial center of the base platform when the base platform is in its natural rest position.

In other embodiments, the system configured to limit side-to-side movement of the base platform during the swinging motion comprises a fin that is rigidly connected to the base platform and which extends downward from the base platform and a guide assembly positioned along a side of (but separate from) the base platform. The guide assembly includes an inner guide element and an outer guide element, with the fin being positioned between the inner guide element and the outer guide element. During the swinging motion, side-to-side movement of the base platform causes the fin (or in some embodiments, another side portion of the swinging element) to contact one of the inner guide element or the outer guide element, thereby limiting side-to-side movement of the base platform. In some embodiments, for instance, the side-to-side movement of the base platform may be limited to the difference between (a) the distance between the inner guide element and the outer guide element and (b) the thickness of the fin.

In some embodiments, the inner guide element, the outer guide element, the fin, or any combination thereof may be configured to reduce friction caused by the fin (or in some embodiments, another side portion of the swinging element) contacting the inner or outer guide element. In some embodiments, for instance, the inner guide element, the outer guide element, the fin, or any combination thereof may comprise a low friction material. In some embodiments, the inner guide element, the outer guide element, the fin, or any combination thereof may comprise a high density plastic, optionally high density polyethylene (HDPE). In some embodiments, for example, the inner guide element, the outer guide element, the fin, or any combination thereof may be made of a low-friction, high density plastic material, such as HDPE.

The inner and outer guide elements may, in some embodiments, extend from a ramp by which a user in a wheelchair accesses and exits the base platform. For instance, the outer guide element may substantially cover a gap between the ramp and the base platform. The inner guide element may extend, e.g. below the outer guide element, to a position substantially underneath the base platform or a sidewall of the swinging element.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a perspective view of an embodiment of a swing assembly in accordance with the present disclosure.

FIG. 2 is side elevation view of the basic structure of a swing assembly in accordance with the present disclosure (without components mounted to the base platform to define positioning of one or more wheelchairs, non-wheelchair occupant users, etc.).

FIG. 3 is a front elevation view of the basic structure of a swing assembly in accordance with the present disclosure (without components mounted to the base platform to define positioning of one or more wheelchairs, non-wheelchair occupant users, etc.).

FIG. 4 is a side elevation view of the basic structure of a swing assembly in accordance with the present disclosure, taken in cross-section to show the interior of one of the overhead tracks and the trolleys configured to move within that interior.

FIG. 5 is a perspective view of a plurality of trolleys and a portion of a rigid framework from an embodiment of a swing assembly in accordance with the present disclosure.

FIG. 6 is a side elevation view of the embodiment from FIG. 1, showing an example radius of curvature of the tracks and an example arc travelled by the base platform during a swinging motion.

FIG. 7 is a side elevation view of an embodiment of a swing assembly in accordance with the present disclosure, showing a track and carriage assembly for reducing side-to-side motion of the swinging element during use.

FIG. 8 is a top, front perspective view of a portion of an embodiment of a swing assembly in accordance with the present disclosure, showing a guide assembly for reducing side-to-side motion of the swinging element during use.

FIG. 9 is a front elevation view, taken in cross-section, of the guide assembly of FIG. 8.

FIG. 10 is a bottom, front perspective view of a portion of an embodiment of a swing assembly in accordance with the present disclosure, showing the guide assembly of FIG. 8.

FIG. 11 is a top perspective view of a portion of an embodiment of a swing assembly in accordance with the present disclosure, showing gap minimization by the guide assembly of FIG. 8.

### DETAILED DESCRIPTION OF THE INVENTION

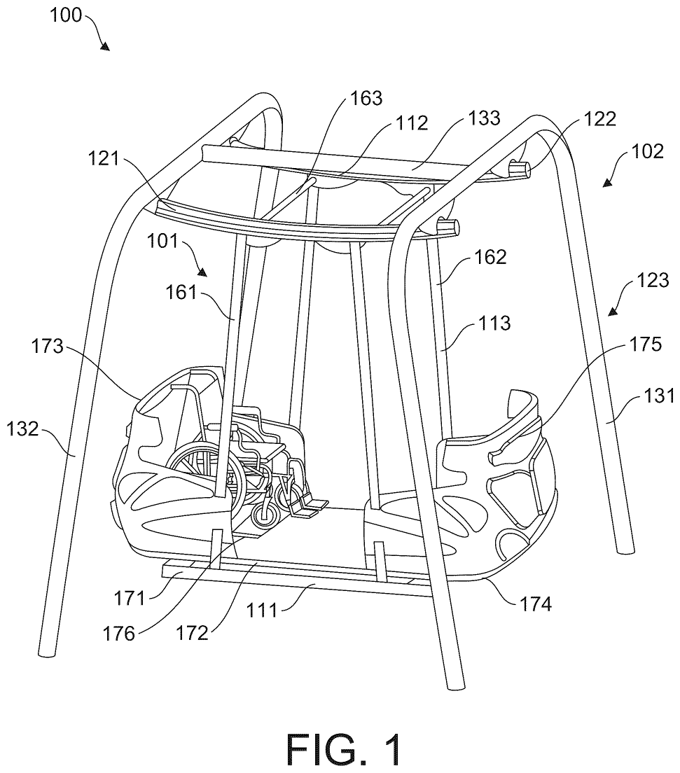

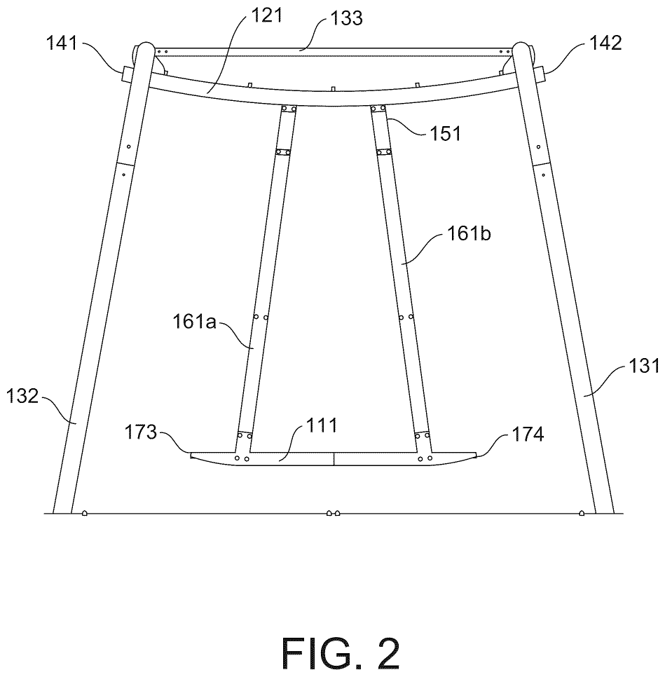

An embodiment of a swing 100 in accordance with the present disclosure is shown in FIGS. 1.

The illustrated embodiment of the swing 100 includes a movable portion 101, also referred to as a swinging element, and a fixed support portion 102, also referred to as a support element. The movable portion 101 includes a base platform 111, a plurality of trolleys 112, and a rigid framework 113 that connects the base platform to the plurality of trolleys. The fixed support portion 102 includes first and second curved tracks 121, 122, and a support structure 123 that holds the first and second curved tracks in an elevated position above a play surface. The base platform is configured to support at least one wheelchair and its occupant, and in many embodiments (including the illustrated embodiment) may be configured to support a plurality of users. The trolleys 112 are configured to move along the first and second curved tracks 121, 122, causing the base platform 111, which is connected to the trolleys by rigid framework 113, to move in a to-and-fro swinging motion.

By utilizing a system of curved tracks 121, 122 and trolleys 112, the swing 100 of the present disclosure provides an occupant of a wheelchair with a to-and-fro swinging motion that is similar to a conventional playground swing, in which the user reaches apexes at the front and rear ends of the swinging motion and passes through a trough at the center of the swinging motion.

The support portion 102 of the swing 100 includes first and second tracks 121, 122 that are held in an elevated, overhead position by a support structure 123. As shown in the illustrated embodiment, the support structure 123 may include a first end unit 131, a second end unit 132, and one or more connector bars 133 that connects the first end unit and the second end unit.

Each end unit 131, 132 may include a pair of legs, each of which has a bottom end that can be mounted to a play surface, e.g. a ground surface, and a crossbar that connects the pair of legs at an upper end. The crossbar is configured to support the first and second curved tracks 121, 122 in any of a variety of manners as would be understood by a person of skill in the art, e.g. as are used to support the track portion of a zip track playground device. The first and second end units 131, 132 may be positioned at or near the ends of the tracks 121, 122, with the crossbar of each end unit supporting each of the tracks at or near one of its ends. If required, additional support elements for the tracks 121, 122 may be included, e.g. by having additional overhead supports extend from the one or more connector bars 133 of the support structure 123 or by including additional independent support structures between the first and second end units 131, 132.

In the illustrated embodiment, the support structure 123 is a standalone structure that supports only the tracks 121, 122. In other embodiments, however, it is contemplated that the support structure 123 could also support tracks for one or more additional wheelchair swings or any of a variety of different playground components, such as one or more zip tracks, monkey bars, conventional swings, or the like.

Each of the first and second tracks 121, 22 may span between a first end 141 and a second end 142. In some embodiments, including the illustrated embodiment, each of the first and second tracks 121, 122 is curved between the first and second ends 141, 142 to provide a swinging motion similar to a conventional playground swing (with apexes at the front and rear of the swinging motion). As the curvature of the first and second tracks 121, 122 determines the intensity of the swinging motion, e.g. how high the apexes of the swinging motion will be, each of the first and second tracks 121, 122 may be curved to provide a desired range of swinging motion.

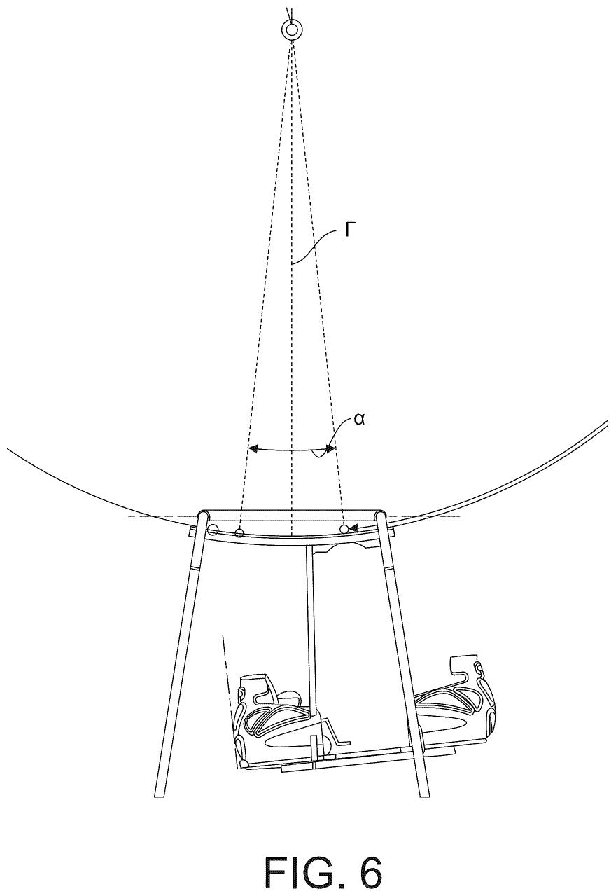

The curvature of the first and second tracks 121, 122 can be defined by their radius of curvature, an example of which is shown in FIG. 6 as reference “r”. A track having a curve with a greater inclination at each end, and thus a lower radius of curvature, will produce a more intense swinging motion and a track having a curve with a lesser inclination at each end, and thus a greater radius of curvature, will produce a more subtle swinging motion. In some embodiments, for example, the first and second tracks may have a radius of curvature (“r”) between about 10 feet and about 30 feet, alternatively between about 12 feet and about 28 feet, alternatively between about 15 feet and about 25 feet, alternatively between about 17 feet and about 23 feet, alternatively about 20 feet. In other, non-illustrated embodiments the first and second tracks may be straight or substantially straight (though the result will be more akin to a gliding motion rather than a swinging motion).

The swinging motion is also defined by the distance that the base platform 111 travels along the first and second tracks 121, 122. As shown in FIG. 6, this can be measured as the arc, identified by reference “a”, travelled by the center of the base platform 111 during a swinging motion (which relates to the length of the track along which the trolleys travel). In some embodiments, for example, the base platform 111 may travel through an arc between about 5 degrees and about 25 degrees, alternatively between about 5 degrees and about 20 degrees, alternatively between about 7 degrees and about 17 degrees, alternatively between about 9 degrees and about 15 degrees, alternatively about 12 degrees.

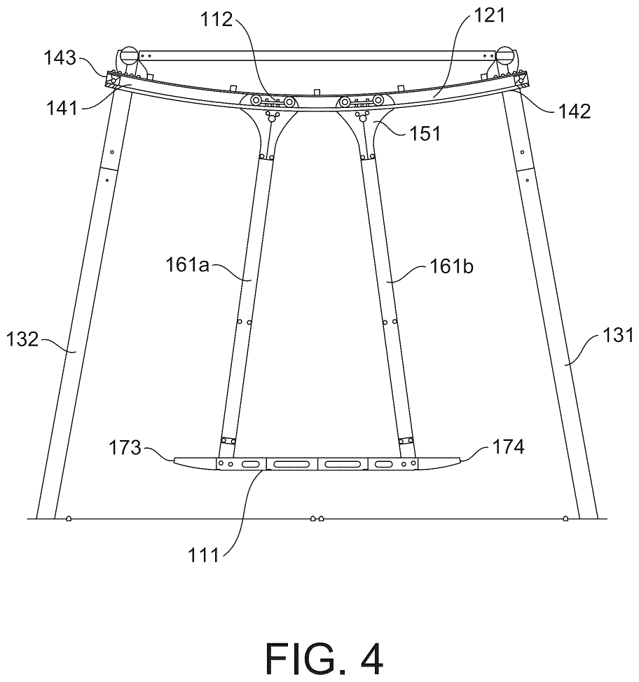

Each of the first and second tracks 121, 122 may also include one or more impact dampening components 143 at each of the first and second ends 141, 142. The impact dampening components 143 are configured to slow the trolleys 112 as they reach the end 141, 142 of the track, thereby preventing a trolley 112 from coming to an abrupt halt that could jostle users of the swing 100. The one or more impact dampening components 143 may include friction-inducing elements, cushioning elements, springs, or the like, or any combination thereof. In the illustrated embodiment, in which the trolleys 112 move along an interior space of the track, the one or more impact dampening components may be positioned within the interior space of the track at each of the first and second ends 141, 142 of the track, as shown for example in FIG. 4.

Each of the plurality of trolleys 112 may be configured to move along one of the first and second tracks 121, 122 in any of a variety of manners.

In the illustrated embodiment, for instance, each of the plurality of trolleys 112 is positioned within an interior space defined by the track, such that the trolley itself is enclosed, except for an extension portion 151 that extends through an opening in the underside of the track. This arrangement can be seen for instance in FIG. 4.

In such an embodiment, each of the first and second tracks 121, 122 may define an interior space that substantially surrounds one or more trolleys 112. The one or more trolleys may have a plurality of wheels 152, or other rollers, that are configured to roll along interior surfaces of the track. In some embodiments, including the illustrated embodiment, the trolley may include a first set of one or more wheels 153 arranged in a vertical direction and configured to roll along an upward-facing surface of the track (e.g. positioned on either side of the opening through which the extension portion 151 of the trolley 112 extends) and a second set of one or more wheels 154 arranged in a horizontal direction and configured to roll along the interior surfaces of the side walls of the track. By providing wheels or the like that operate on two different axes, movement of the trolley 112 along the track 121, 122 is made more stable, e.g. rocking or shaking is significantly reduced, and more durable, e.g. chances of failure are reduced.

In other, non-illustrated embodiments, each of the plurality of trolleys 112 may substantially surround the track, and rollers positioned on the interior of the trolley may slide along exterior surfaces of the track.

The base platform 111 of the swing is connected to the plurality of trolleys 112 through a rigid framework 113. In some embodiments, the rigid framework may be made of metal such as steel or aluminum. The rigid framework can take on any of a variety of configurations, with the primary focus being on providing a stable and durable connection between the base platform 111 and the trolleys 112 given that the base platform will support a large amount of weight and move through the swinging arc defined by the curvature of the first and second tracks 121, 122. In the illustrated embodiment, the rigid framework 113 includes a first set of members 161 positioned along a first side of the base platform 111, each of which has a first end connected to the base platform at or near the first side of the base platform and a second end connected to a first set of one or more trolleys 112 that move along the first track 121 (e.g. through attachment to the extension portion(s) 151 of the trolley(s)) and a second set of members 162 positioned along a second side of the base platform, each of which has a first end connected to the base platform at or near the second side of the base platform and a second end connected to a second set of one or more trolleys 112 that move along the second track 122 (e.g. through attachment to the extension portion(s) 151 of the trolley(s)).

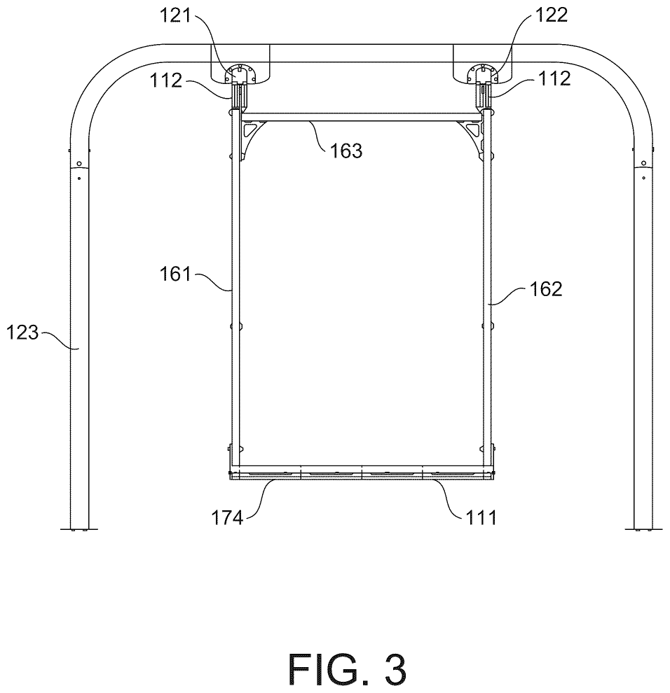

In the illustrated embodiment, each set of members 161, 162 includes two members. This is shown in FIG. 3, where the two members of the first set of members 161 are identified by reference numbers 161a and 161b. The two members desirably provide a space between them, through which users may enter and exit the base platform 111. In the illustrated embodiment, for instance, a user—including an occupant of a wheelchair—may access the base platform 111 via a ramp 300 (a) on the first side of the base platform between the first set 161 of members, (b) on the second side of the base platform between the second set 162 of members, or (c) both (a) and (b).

In the illustrated embodiment, each member, e.g. 161a and 161b, is connected to a trolley 112, such that two trolleys move along each track, e.g. 121. In other, non-illustrated embodiments, however, each member, e.g. 161a and 161b, may connect to the same trolley, such that only one trolley moves along each track, e.g. 121.

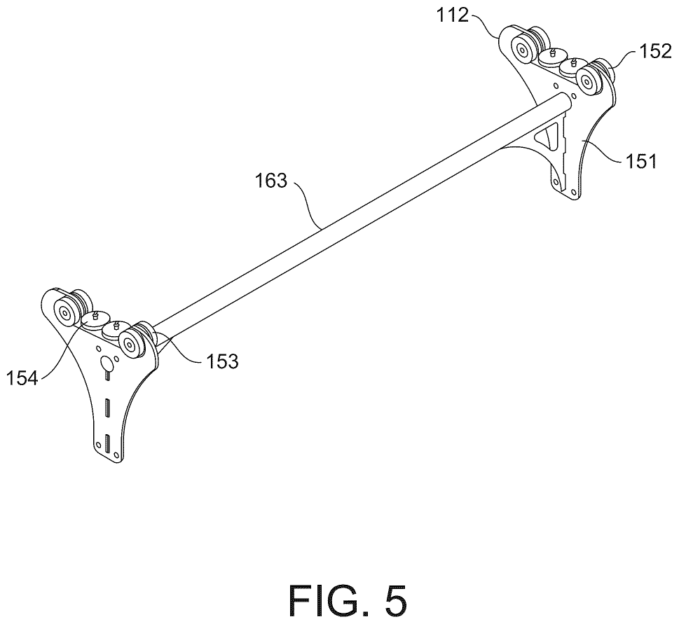

The rigid framework 113 may also include any number of stabilizing crossbar members 163, each of which connects one of the first members 161 and one of the second members 162. These crossbar members 163 may be connected to the extension portions 151 of the trolleys 112 to which each member 161, 162 is secured, as shown in FIG. 5, or they may be connected directly to each of the members.

Though a rigid framework 113 having a specific arrangement is shown and described, it is contemplated that other arrangements may be used in its place, so long as the rigid framework provides a connection between the base platform 111 and the trolleys 112 that remains stable and durable throughout the swinging motion and does not unduly interfere with users accessing and exiting the base platform.

The base platform 111 may comprise one or more layers. In the illustrated embodiment, for example, the base platform 111 includes a lower layer 171 made of a strong metal material, e.g. steel, that provides the swing 100 with improved weight-bearing capabilities and an upper layer 172 on which the swing user(s) rides the swing. The upper layer 172 may be made of any weather-resistance material, including for example molded plastic. In the embodiment shown in FIG. 1, for example, the upper layer 172 is made up of two units of the same roto-molded plastic component, with the split being directly down the center (running between the first and second sides of the base platform). By rotating the units of a molded plastic component in this way, a single plastic component can be used to create the entire upper layer 172. In other embodiments, a combination of different molded plastic components (as opposed to multiple units of the same plastic component) can be used to create the upper layer 172 or the upper layer can consist of a single component.

The rigid framework 113 may be secured to any of the one or more layers of the base platform 111 in any known manner, including for example welding, conventional fasteners (e.g. bolts, etc.), or the like.

In some embodiments, including the illustrated embodiment, the swing 100 may be configured to that, when installed on a play surface of a playground, the underside of the base platform 111 is positioned at least twelve inches above the play surface at its lowest point during a swinging motion, optionally at least thirteen inches above the play surface, optionally at least fourteen inches above the play surface, optionally at least fifteen inches above the play surface, optionally at least sixteen inches above the play surface. The space between the underside of the base platform 111 and the play surface should remain free of any components or obstructions. In order to provide a swing 100 in which there is a desired amount of empty space between the underside of the base platform 111 and the underlying play surface, embodiments of the swing 100 of the present disclosure do not have a skirt or any separate component under the base platform.

The base platform 111 may be configured to hold any combination of (a) one or more users that are occupying a wheelchair(s), (b) one or more users that are not occupying a wheelchair(s), or (c) any combination of one or more users that are occupying a wheelchair(s) and one or more users that are not occupying a wheelchair(s). In some embodiments, including for example the embodiment illustrated in FIG. 1, a first end of the base platform 173 may be configured to support at least a first user that is occupying a wheelchair and a second end of the base platform 174 may be configured to support at least a second user that is occupying a wheelchair. One or both of the first and second ends of the base platform 173, 174 may also be configured to support a user that is not occupying a wheelchair. In the embodiment illustrated in FIG. 1, for example, each of the first and second ends of the base platform 173, 174 may have a rigid seat, e.g. bench, next to the space that is sized and configured to hold a wheelchair. In other embodiments, a first end of the base platform 173 may be configured to hold one or more users that are occupying a wheelchair(s) and a second end of the base platform 174 may be configured to hold one or more users that are not occupying a wheelchair(s). In yet other non-illustrated embodiments, the swing may be configured such that one or more users occupying a wheelchair(s) are positioned at or near the center of the base platform 111 as opposed to at the first and/or second end of the base platform 173, 174.

Each of the first and second ends of the base platform 173, 174 may include an end wall 175. The end wall 175 may extend across the entirety of the base platform 111, i.e. spanning between the first side and the second side of the base platform. As shown in the embodiment illustrated in FIG. 1, the end wall 175 may also wrap, e.g. curve, around and extend some distance up each of the first and second sides of the base platform 111. This provides easily identifiable compartments on each of the first and second ends of the base platform 173, 174 in which the users are meant to ride the swing 100. In alternative embodiments, the base platform 111 may include partial side walls that are separate (not integral with) the end walls 175.

As shown in the embodiment illustrated in FIG. 1, the end walls 175 may be integrally formed as part of the upper layer 172 of the base platform. In alternative embodiments that include separate partial side walls, those partial side walls may also be integrally formed as part of the upper layer 172 of the base platform. Alternatively, the end walls 175 (and if present partial side walls) may be attached to the base platform 111, e.g. through conventional means such as welding, fasteners (e.g. bolts), or the like.

Each end wall 175 may have an outer surface that is rounded (i.e. curved) in order to reduce impact forces should an individual accidentally enter the pathway of the swing 100 during use. In some embodiments, each end wall 175 may also include additional impact-dampening components such as rubber bumpers or the like. In some embodiments, the swing 100 is configured to have a peak acceleration of 100 g or less and a head impact score of 500 or less, each of which being tested in accordance with ASTM F1387, section 8.6.7.

The inner surface of the end wall 175 may be designed to provide a desired seating arrangement. In the embodiment illustrated in FIG. 1, for example, the inner surface of each end wall 175 is be configured to provide a space in which a wheelchair can be positioned and, next to that space, a rigid seat for an additional user. In other embodiments, however, the inner surface of either or both end walls 175 may be configured to provide only a space in which a wheelchair can be positioned or only a seat (or seats) for one or more users not occupying a wheelchair(s).

Embodiments of the swing 100 may also include one or more components that stabilize a wheelchair, e.g. prevent rolling of the wheels of a wheelchair during the swinging motion, at one or more positions where the swing is configured to support a wheelchair during use. These components may be positioned on the top surface of the base platform 111, e.g. the top of the upper layer 172 where the base platform comprises multiple layers, and/or on one or both of the end walls 175. For instance, the upper surface of the base platform 111 may include one or more protrusions or one or more depressions that are configured to prevent movement of the wheels of a wheelchair during the swinging motion. In the embodiment illustrated in FIG. 1, for example, the upper layer 172 of the base platform 111 comprises a protrusion 176 that is configured to prevent movement of the wheels of a wheelchair. In other, non-illustrated embodiments, the end wall 175 could include one or more clamps or straps configured to stabilize the wheelchair during the swinging motion. In some embodiments, including that illustrated in FIG. 1, no bars or other components are positioned directly in front of a user occupying a wheelchair.

Embodiments of the swing 100 may also include a system 200 for reducing or eliminating the side-to-side movement, e.g. rocking, of the swinging element 101 during use.

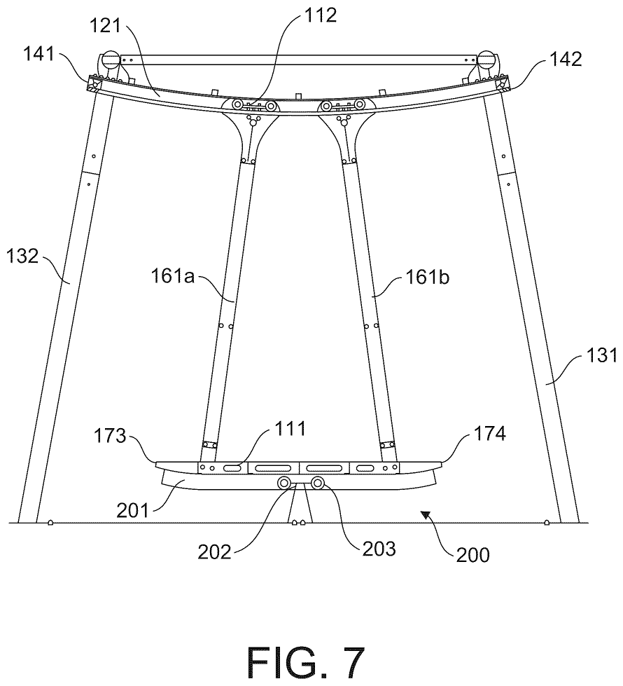

A first example of such a stabilizing system 200 is shown in FIG. 7. In this embodiment, the stabilizing system includes a track 201 on an underside of the base platform 111 and a trolley 202 that is fixed in place below the base platform. The system is configured so that as the base platform 111 moves during the swinging motion, the track 201 will move about the fixed trolley 202. By providing an additional track 201 and trolley 202 assembly at the bottom of the swing 100, the side-to-side movement of the base platform 111 during the swinging motion may be reduced or even eliminated. Moreover, the track 201 and trolley 202 assembly can be configured to minimize friction, thereby minimizing the effects of the system 200 on the swinging motion.

Where using only a single track 201 and trolley 202 assembly, as in the illustrated embodiment, in order to provide the greatest stabilizing effect, the track 201 may be positioned substantially centrally between a first side and a second side of the base platform 111 and the trolley 202 may be positioned at the substantial center of the base platform when the base platform is in its natural rest position (i.e., the distance from the trolley to each side of the base platform is substantially equivalent and the distance from the trolley to each end of the base platform is substantially equivalent, taking into account normal tolerances that would be understood by those skilled in the art).

The track 201 may, in some embodiments, be part of the lower layer 171 of the base platform and may, along with other members, serve to support the upper layer 172 on which the swing user(s) rides the swing. In other embodiments, the track 201 may be mounted to base platform 111, e.g. to the lower layer 171 where a multiple layer configuration is utilized by conventional means.

In some embodiments, including that shown in FIG. 7, the track 201 may span substantially the length of the base platform 111 between the first and second ends 173, 174. In this way, it may be ensured that the track 201 remains in engagement with the trolley 202 across the entire swinging motion. In other embodiments, however, and depending on the distance travelled by the base platform 111 during the swinging motion, the track 201 may have different lengths, e.g. may span less than substantially the full length of the base platform between the first and second ends 173, 174.

The trolley 202 is positioned at a fixed location below the base platform 111. In some embodiments, including that shown in FIG. 7 for instance, the trolley 202 may mounted to a ground surface below the base platform 111. Alternatively, the trolley 202 may be attached to an element that extends inward from a ramp 300 unit.

The track 201 and trolley 202 assembly may be configured so that the track moves along the trolley in any of a variety of manners.

In some embodiments, the track 201 and trolley 202 assembly may be configured in much the same manner as the overhead track and trolley described above. In some embodiments, for instance, the trolleys 202 may be positioned within an interior space defined by the track 201, such that the trolley itself is enclosed, except for a portion that extends through an opening in the underside of the track. In such an embodiment, the track 201 may define an interior space that substantially surrounds the trolley 202.

The trolley 202 may have a plurality of wheels 203, or other rollers, that are configured to roll along interior surfaces of the track 201 as the track moves about the trolley. In some embodiments, the trolley 202 may include a first set of one or more wheels arranged in a vertical direction and configured to roll along an upward-facing surface of the track (e.g. positioned on either side of the opening through which the extension portion of the trolley extends) and a second set of one or more wheels arranged in a horizontal direction and configured to roll along the interior surfaces of the side walls of the track. By providing wheels or the like that operate on two different axes, movement of the track 201 about the trolley 202 is made more stable, e.g. rocking or shaking is significantly reduced, and more durable, e.g. chances of failure are reduced.

In other embodiments, the trolley 202 may substantially surround the track 201, and wheels or other rollers positioned on the interior of the trolley may slide along exterior surfaces of walls of the track.

In an alternative, non-illustrated embodiment of a stabilizing system 200, a track 201 and trolley 202 assembly such as that described above may instead be placed along a side of the base platform 111. In such an embodiment, for instance, the trolley 202 may be mounted to a ramp 300 by which a user in a wheelchair to enter and exit the base platform, e.g. at a fixed location below the upper surface of the ramp, and the track 201 may be positioned on the side of the base platform 111, or vice-versa.

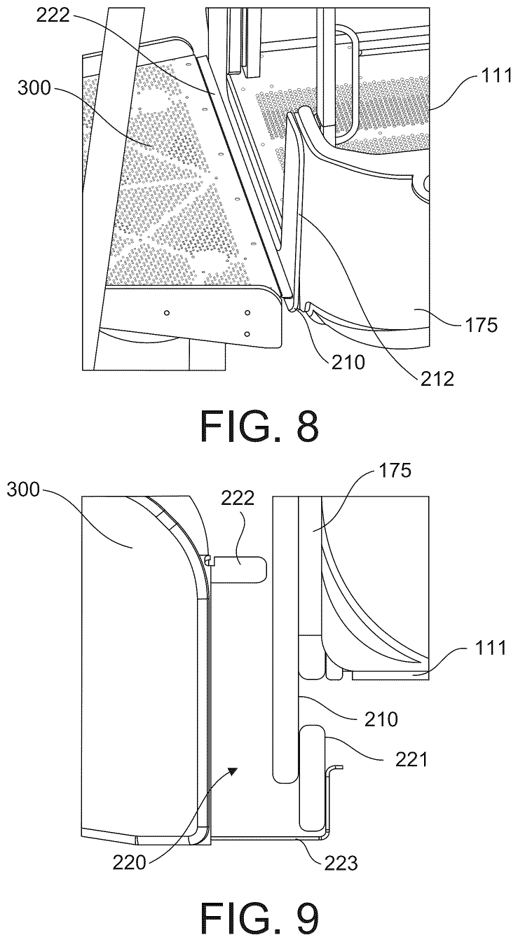

A second example of a system 200 for reducing or eliminating the side-to-side movement, e.g. rocking, of the swinging element 101 during use is shown in FIGS. 8 to 11. Rather than a track 201 and trolley 202 assembly such as that described above, this system utilizes a fin 210 that extends downward from the base platform 111, e.g. along the side of the base platform, and a guide assembly 220 positioned adjacent (but independent from) the side of the base platform. The guide assembly 220 includes an inner guide element 221 and an outer guide element 222.

As best seen in FIG. 9, the fin 210 is positioned between the inner guide element 221 and an outer guide element 222, such that side-to-side movement of the fin 210—and hence movement of the swinging element 201 of which the fin forms a part—is limited to the distance between the inner guide element and the outer guide element (and more specifically to the difference between (i) the distance between the inner guide element and the outer guide element and (ii) the thickness of the fin).

As the swinging element 201 moves from side-to-side during the swinging motion, the fin 210 will come into contact with one of the inner guide element 221 and the outer guide element 222. In order to minimize interference of the stabilization system 200 with the swinging motion, it is desirable to reduce friction between the fin 210 and each of the guide elements 221, 222 when they do contact one another.

In some embodiments, therefore, the inner guide element, the outer guide element, or both may comprise a low-friction material. This may comprise a low friction coating on the contacting surface of the guide element 221, 222 or it may comprise the guide element itself being made of a low-friction material (or both). Additionally, the guide elements 221, 222 need to be strong enough to withstand contact with the fin 210 without failure (cracking, breaking, etc.). In some embodiments, the inner guide element, the outer guide element, or both may be made of a high density plastic such as (but not limited to) high density polyethylene (HDPE).

Similarly, in some embodiments, the fin 210 may comprise a low-friction material. This may comprise a low friction coating on the guide element-contacting surfaces of the fin 210 or it may comprise the fin itself being made of a low-friction material (or both). Additionally, the fin 210 needs to be strong enough to withstand contact with the guide elements 221, 222 without failure (cracking, breaking, etc.). In some embodiments, the fin 210 may be made of a high density plastic such as (but not limited to) high density polyethylene (HDPE).

In some embodiments, including that illustrated in FIGS. 8 to 11, the guide assembly 220 may be mounted to a ramp 300 by which a user in a wheelchair enters and exits the swinging element 101.

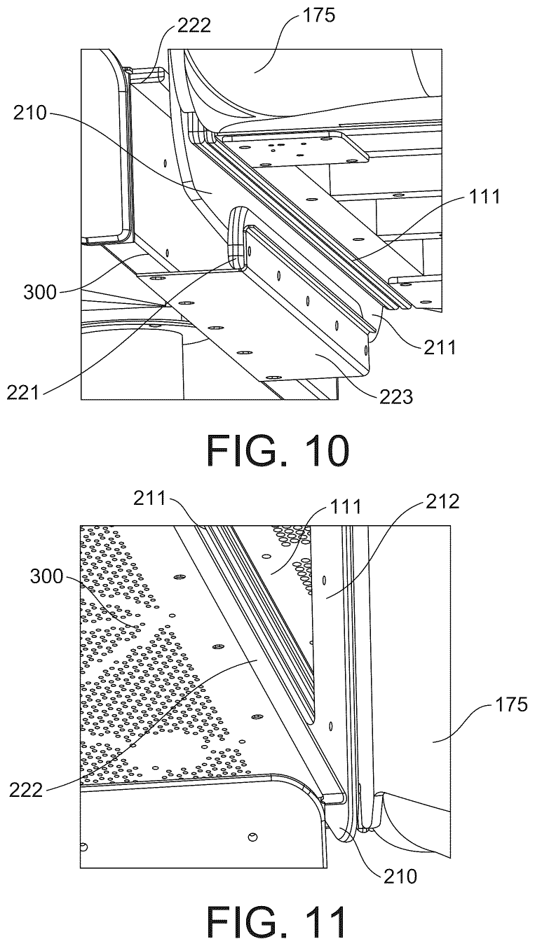

For instance, the outer guide element 222 may extend from the ramp 300 toward the swinging element 101. As in the illustrated embodiment, the outer guide element 222 may be positioned only a small distance below the upper surface of the ramp. In doing so, the outer guide element 222 serves not only to reduce side-to-side motion of the swinging element 101, but also to substantially cover a gap between the ramp 300 and the swinging element 101. The inner guide element 221 may extend from the ramp 300 to a position substantially underneath a side of the base platform 111. As seen in FIGS. 9 and 10, for example, the inner guide element 221 may be attached to a mounting bracket 223 that extends a desired distance from the ramp 300. The inner guide element 221 may be positioned lower vertically than the outer guide element 222. As illustrated, for example, the mounting bracket 223 for the inner guide element 221 may be positioned vertically below the outer guide element 222.

The fin 210 may be attached to one or more other portions of the swinging element 101, including for example the base platform 111, a portion of a side wall (including for example a side wall portion formed by an end wall element 175 extending along a side), or both. In some embodiments, for instance, the fin 210 may be attached to an outer side surface of the base platform 111; a portion of a wall extending along the side of the base platform, optionally a portion of an end wall 175 that extends along the side of the base platform; or a combination thereof. In other embodiments, the fin may be integral with one or more other portions of the swinging element 101, including for instance the base platform 111, a portion of a side wall (including for example a side wall portion formed by an end wall element 175 extending along a side), or both. In some embodiments, for instance, the fin 210 may be integral with and extend downward from a portion of the base platform 111; a portion of a wall extending along the side of the base platform, optionally a portion of an end wall 175 that extends along the side of the base platform; or a combination thereof.

In the illustrated embodiment, the fin 210 is shown as having a portion 211 attached to a side of the base platform 111 and to also have wings 212 that extend upward and are attached to side wall portions formed by first and second end wall elements 175. As noted above, however, other configurations are also contemplated.

The fin 210, the inner guide element 221, and the outer guide element 222 may have lengths that are selected to ensure that the fin 210 is positioned between the inner guide element and the outer guide element throughout the entire arc of the swinging motion.

In some embodiments, the system may be configured so that the fin 210 abuts against the inner guide element 221 when the swinging element 101 is in its natural rest position, as shown for example in FIG. 9. When undergoing a swinging motion, however, the fin 210 will move side-to-side within the small gap between the inner and outer guide elements 221, 222, such that at points it may contact the inner guide element, at other points it may contact the outer guide element, and at other points it may not contact either guide element. In other embodiments, the system may be configured so that the fin 210 is not abutting either guide element 221, 220 when the swinging element 101 is in its natural rest position.

In alternative embodiments, the fin 210 may only come into contact with the inner guide element 221 and an alternative portion, e.g. a side wall portion, of the swinging element 101 may come into contact with the outer guide element 22 in order to reduce side-to-side movement of the swinging element during the swinging motion. In such an embodiment, for instance, the fin 210 may extend directly down from the outer surface of a side wall portion of the swinging element. The guide assembly 220 may be largely the same as in the illustrated embodiment (taking into account that the distances each of the inner guide element 221 and outer guide element 222 extend from the ramp 300 may need to be varied to ensure that the fin 210 extends between the inner and outer guide elements).

In some embodiments, a single stabilizing system 200 such as that shown in FIGS. 8 to 11 may be provided. In other embodiments, the swing assembly 100 may comprise two ramps 300, one on each side of the swinging element 101, and the swing assembly may include two stabilizing systems 200 such as that shown in FIGS. 8 to 11, e.g. with a first guide assembly 220 extending from a first ramp and a second guide assembly extending from a second ramp and with a first fin 210 positioned on a first side of the swinging element 101 and a second fin positioned on a second side of the swinging element.

It can be seen that the described embodiments provide a unique and novel swing 100 that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A swing configured for use by a person on a wheelchair, the swing comprising:
a base platform configured to support at least one wheelchair;
first and second curved overhead tracks, each of the first and second curved overhead tracks being maintained in an elevated position by a support structure;
a first set of one or more trolleys configured to move along the first overhead track;
a second set of one or more trolleys configured to move along the second overhead track;
a rigid framework that connects the base platform to the first set of one or more trolleys and the second set of one or more trolleys, such that movement of the trolleys along the first and second overhead tracks causes the base platform to move in a swinging motion.

2. The swing of claim 1, wherein the first and second overhead tracks run substantially parallel to first and second sides of the base platform.

3. The swing of any claim 1, wherein each of the first and second overhead tracks is curved.

4. The swing of claim 3, wherein each of the first and second overhead tracks has a radius of curvature between about 10 feet and about 30 feet, optionally between about 12 feet and about 28 feet, optionally between about 15 feet and about 25 feet, optionally between about 17 feet and about 23 feet.

5. The swing of any claim 3, wherein the base platform travels through an arc that is between about 5 degrees and about 25 degrees, optionally between about 5 degrees and about 20 degrees, optionally between about 7 degrees and about 17 degrees, optionally between about 9 degrees and about 15 degrees.

6. The swing of claim 1, wherein each of the first and second overhead tracks comprises impact dampening components at each end.

7. The swing of claim 1, wherein the swing is configured to support a wheelchair at (a) a first end of the base platform, (b) a second end of the base platform, or (c) both (a) and (b).

8. The swing of claim 7, wherein the swing further comprises a rigid seat for use by a person that is not on a wheelchair at (a) a first end of the base platform, (b) a second end of the base platform, or (c) both (a) and (b).

9-12. (canceled)

13. The swing of claim 1, wherein each of the first end of the base platform and the second end of the base platform comprises an end wall, and wherein each end wall is rounded to reduce impact force.

14. (canceled)

15. The swing of claim 1, wherein the rigid framework comprises
a first set of two or more members, each of which has a first end connected to the base platform at or near a first side of the base platform and a second end operably connected to the first set of one or more trolleys; and
a second set of two or more members, each of which has a first end connected to the base platform at or near a second side of the base platform and a second end operably connected to the second set of one or more trolleys.

16. The swing of claim 15, wherein the swing is configured for a user in a wheelchair to enter and exit the base platform via a ramp (a) on the first side of the base platform between the first set of two or more members, (b) on the second side of the base platform between the second set of two or more members, or (c) both (a) and (b).

17. Cancelled.

18. The swing of claim 17, wherein the first set of one or more trolleys comprises at least two trolleys, and the second set of one or more trolleys comprises at least two trolleys; and
wherein the rigid framework comprises:
a first member having a first end connected to the base platform at or near a first side of the base platform and a second end operably connected to a first one of the at least two trolleys of the first set of one or more trolleys;
a second member having a first end connected to the base platform at or near a first side of the base platform and a second end operably connected to a second one of the at least two trolleys of the first set of one or more trolleys;
a third member having a first end connected to the base platform at or near a second side of the base platform and a second end operably connected to a first one of the at least two trolleys of the second set of one or more trolleys;
a fourth member having a first end connected to the base platform at or near a second side of the base platform and a second end operably connected to a second one of the at least two trolleys of the second set of one or more trolleys.

19-20. (canceled)

21. The swing of any preceding claim 1, wherein the underside of the base platform is positioned at least twelve inches above an underlying play surface at the lowest point during a swinging motion.

22. (canceled)

23. The swing of claim 1, wherein the swing is configured to have a peak acceleration of 100 g or less and a head impact score of 500 or less, each of which being tested in accordance with ASTM F1387, section 8.6.7.

24. The swing of claim 1, wherein the swing comprises a system configured to limit side-to-side movement of the base platform during the swinging motion.

25. The swing of claim 24, wherein the system configured to limit side-to-side movement of the base platform during the swinging motion comprises:
a track on an underside of the base platform; and
a trolley that is fixed in place below the base platform;
wherein the track is configured to move about the trolley during the swinging motion.

26-30. (canceled)

31. The swing of claim 24, wherein the system configured to limit side-to-side movement of the base platform during the swinging motion comprises:
a fin extending downward along a side of the base platform; and
a guide assembly positioned along a side of the base platform, the guide assembly comprising an inner guide element and an outer guide element;
wherein the fin is positioned between the inner guide element and the outer guide element.

32. The swing of claim 31, wherein the side-to-side movement of the base platform is limited to the difference between (a) the distance between the inner guide element and the outer guide element and (b) the thickness of the fin.

33-34. (canceled)

35. The swing of claim 31, wherein the outer guide element extends from a ramp configured for a user in a wheelchair to enter and exit the base platform.

36. (canceled)

37. The swing of claim 35, wherein the inner guide element extends from a ramp configured for a user in a wheelchair to enter and exit the base platform to a position substantially underneath the base platform.

38-43. (canceled)
